(19) United States
(12) Patent Application Publication
(10) Pub. No.: US 2005/0021386 A1
(43) Pub. Date: Jan. 27, 2005

(54) Method and system for forecasting a potential cost of an indirect procurement commodity

(76) Inventor: Lloyd Paul Mills, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/626,071

(22) Filed: Jul. 23, 2003

(51) Int. Cl. G06F 17/60

(52) U.S. Cl. 705/10

(57) ABSTRACT

A method and system for forecasting a potential cost for an indirect procurement commodity is disclosed. Based on the forecasted potential cost, the indirect procurement commodity can be block purchased for a predetermined duration and period of time. Consequently, a substantial reduction in the costs associated with the purchase of indirect procurement commodities can be achieved. An aspect of the present invention is a method for forecasting a potential cost for an indirect procurement commodity. The method includes receiving a volume of the indirect procurement commodity to be block purchased for a future period, calculating a cost of the volume of the indirect procurement commodity based on historical consumption data for a past period and forecasting a potential cost of the indirect procurement commodity to be purchased for a future period based on the calculated cost and at least one variable factor associated with the indirect procurement commodity.

### FIELD OF THE INVENTION

The present invention relates generally to commodity purchasing and more particularly to a method and system for forecasting a potential cost of an indirect procurement commodity.

### BACKGROUND OF THE INVENTION

Indirect procurement commodities are a necessary expense for almost any business venture. An indirect procurement commodity refers to any commodity or service that a company buys that does not result directly in finished goods for sale. Real estate, energy consumption, fixtures, staplers, paper, furniture, contract workers, computers and travel services are all examples of indirect procurement commodities. Indirect procurement typically accounts for over 60 percent of a company's purchasing transactions.

With regard to energy consumption, businesses have traditionally only been able to purchase energy on a full requirements contract structure. A full requirements contract is a contract in which the energy company agrees to provide all the energy to the business at a relatively high price per unit of energy consumed. The high price of the energy is based on the notion that the energy company is taking all of the risk involved in the commitment to supply all of the energy to the business. This risk is associated with the fact that the energy needs of the business tend to fluctuate and the energy company will either turn on too many generators or not enough generators. By charging businesses a relatively high price per unit of energy consumed, energy companies are assured a profit whether too many generators are turned on or not enough generators are turned on.

However, deregulation in the energy market now allows for competition between various energy generation companies and energy resellers/providers, along with ability to negotiate new contract structures. One such contract structure is called a block purchase contract. A block purchase contract is a contract in which a business agrees to purchase a certain amount of energy at an hourly rate at a specified price for a future duration. This is also known as a forward contract. The implementation of a block purchase contract allows some of the risk in the energy purchase process to be passed on to the commodity consumer. By committing to purchase a certain amount of energy at an hourly rate at specified price, the business essentially has to use that amount of energy. If the business doesn't use all of the purchased energy, money is wasted in the sense that the business has paid for energy that wasn't used. If the business uses more energy than the amount purchased, the business has to purchase energy on the open market potentially at a rate substantially higher than the negotiated block purchase rate again resulting in a waste of money for the business.

Accordingly, what is needed is a method and system that is capable of forecasting a potential cost that is associated with indirect procurement commodity purchases. The method and system should be simple, inexpensive and capable of being easily adapted to existing technology. The present invention addresses these needs.

### SUMMARY OF THE INVENTION

The present invention includes a method and system for forecasting a potential cost for an indirect procurement commodity. In accordance with varying embodiments, the present invention can forecast the potential cost associated with block purchases of the indirect procurement commodity by statistically analyzing a history of consumption of the indirect procurement commodity. Based on the forecasted potential cost, the indirect procurement commodity can be block purchased for a predetermined duration and period of time. Consequently, a substantial reduction in the costs associated with the purchase of indirect procurement commodities can be achieved.

A first aspect of the present invention is a method for forecasting a potential cost for an indirect procurement commodity. The method includes receiving a volume of the indirect procurement commodity to be block purchased for a future period, calculating a cost of the volume of the indirect procurement commodity based on historical consumption data for a past period and forecasting a future potential cost of the indirect procurement commodity to be purchased for a future period based on the calculated cost and at least one variable factor associated with the indirect procurement commodity.

A second aspect of the present invention is a system for forecasting a potential cost for an indirect procurement commodity. The system includes a graphical user interface and a cost forecasting tool coupled to the graphical user interface capable of: receiving a volume of the indirect procurement commodity to be block purchased for a future period, calculating a cost of the volume of the indirect procurement commodity based on historical consumption data for a past period and forecasting a future potential cost of the indirect procurement commodity to be purchased for a future period based on the calculated cost and at least one variable factor associated with the indirect procurement commodity.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a high-level flow chart of a method in accordance with an embodiment of the present invention.

FIG. 2 is an illustration of a system for forecasting a potential cost for an indirect procurement commodity in accordance with an embodiment of the present invention.

FIG. 3 is a block diagram of a computer system that could be utilized in conjunction with an embodiment of the present invention.

FIG. 4 shows an example of a data matrix in accordance with an embodiment of the present invention.

FIG. 5 shows an example of an index price table in accordance with an embodiment of the present invention.

FIG. 6 is an example of a graphical user interface that could be utilized in conjunction with an embodiment of the present invention.

FIG. 7 is a more detailed flowchart of a method in accordance with an embodiment of the present invention.

### DETAILED DESCRIPTION

The present invention relates to a method and system for forecasting a potential cost for an indirect procurement commodity. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, the invention is a method and system for forecasting a potential cost for an indirect procurement commodity. The present invention in varying embodiments, forecasts the potential cost associated with various volume block purchases of the indirect procurement commodity by statistically analyzing a history of consumption of the indirect procurement commodity and multiplying it by a probable price. Based on the forecasted potential cost, the indirect procurement commodity can be block purchased for a predetermined duration and period of time. Consequently, a substantial reduction in the costs associated with the purchase of indirect procurement commodities can be achieved.

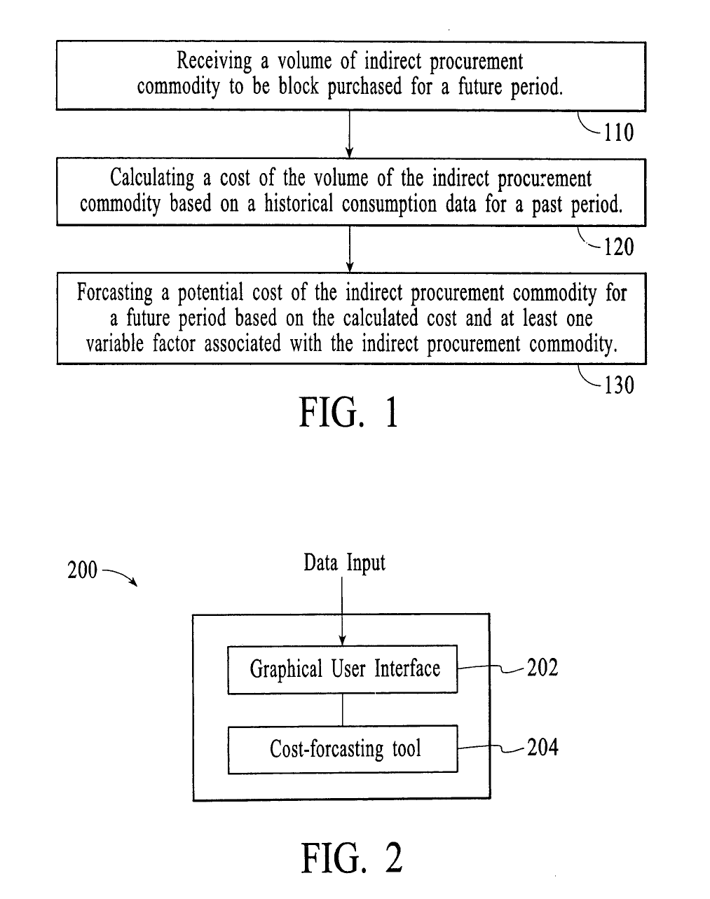

FIG. 1 is a high level flow chart of a method in accordance with an embodiment of the present invention. A first step 10 includes receiving a volume of the indirect procurement commodity to be block purchased for a future period. A second step 120 involves calculating a cost of the volume of the indirect procurement commodity based on historical consumption data for a past period. A final step 130 includes forecasting a potential cost of the indirect procurement commodity for a future period based on the calculated cost and at least one variable factor associated with the indirect procurement commodity

FIG. 2 is an illustration of a system 200 for forecasting a potential cost for an indirect procurement commodity in accordance with an embodiment of the present invention. System 200 includes a graphical user interface 202 and a cost-forecasting tool 204. A graphical user interface includes a combination of menus, screen design, keyboard commands and command language, which creates the way a user interacts with a computer. Although the above-disclosed embodiment of the present invention is described as being utilized in conjunction with a graphical user interface, one of ordinary skill in the art will readily recognize that any of a variety of user interfaces could be implemented while remaining within the spirit and scope of the present invention.

In an embodiment, the cost-forecasting tool 204 is Excel-based. Excel is a full-featured spreadsheet program for computer systems from Microsoft. It has the capability to link many spreadsheets for consolidation and provides a wide variety of business graphics and charts for creating presentation materials. However, one of ordinary skill in the art will readily recognize that a variety of computer programs could be utilized while remaining within the spirit and scope of the present invention. Accordingly, the risk calculation tool 204 utilizes stored statistical formulas to operate upon received commodity consumption data in order to forecast future cost related to the consumption of an indirect procurement commodity.

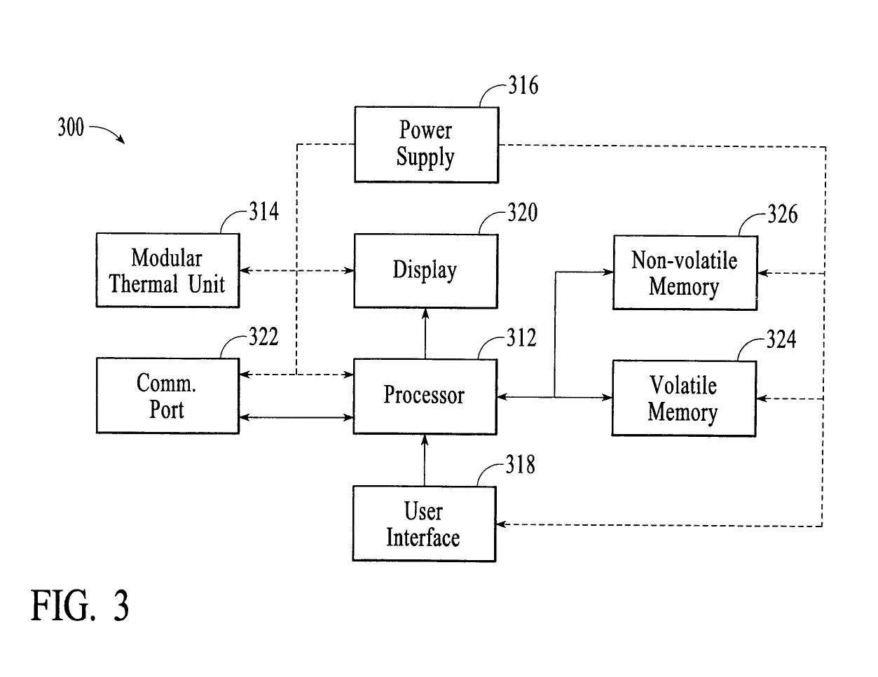

System 200 may be implemented as one or more respective software modules operating on a computer system. For an example of such a computer system, please refer to FIG. 3. In FIG. 3, a block diagram of a computer system, generally designated by the reference numeral 300, is featured. Computer 300 may be any of a variety of different types, such as a notebook computer or a desktop computer. In the illustrated embodiment, a processor 312 controls the functions of computer system 300. In this embodiment, data, as illustrated by the solid line, is transferred between the processor 312 and the components of system 300. Additionally, a modular thermal unit 314 is used to remove heat from the processor 312. Computer 300 also includes a power supply 316 to supply electrical power, as illustrated by the dashed line, to the components of computer system 300. Additionally, power supply 316 may include a battery for portable use of computer 300.

Computer system 300 may incorporate various other components depending upon the desired functions of computer 300. In the illustrated embodiment, a user interface 318 is coupled to processor 312. Examples of a user interface 318 include a keyboard, a mouse, and/or a voice recognition system. Additionally, a display 320 is coupled to processor 312 to provide a user with visual information. Examples of a display 320 include a computer monitor, a television screen, or an audio system. In this embodiment a communications port 322 is coupled to processor 312 to enable the computer system 300 to communicate with an external device or system, such as a printer, another computer, or a network.

Processor 312 utilizes software programs to control the operation of computer 300. Electronic memory is coupled to processor 312 to store and facilitate execution of the programs. In the illustrated embodiment, processor 312 is coupled to a volatile memory 324 and non-volatile memory 326. A variety of memory modules, such as DIMMs, DRAMs, SDRAMs, SRAMs, etc., may be utilized as volatile memory 324. Non-volatile memory 326 may include a hard drive, an optical storage, or another type of disk or tape drive memory. Non-volatile memory 326 may include a read only memory (ROM), such as an EPROM, to be used in conjunction with volatile memory 324.

The system 300 may also be utilized in conjunction with a distributed computing environment where tasks are performed by remote processing devices that are linked through a communications network. In a distributed computing environment, program modules may be located in both local and remote memory storage devices. Execution of the program modules may occur locally in a stand-alone manner or remotely in a client/server manner. Examples of such distributed computing environments include local area networks of an office, enterprise-wide computer networks, and the Internet. Additionally, the networks could communicate via wireless means or any of a variety of communication means while remaining within the spirit and scope of the present invention.

The above-described embodiment of the invention may also be implemented, for example, by operating a computer system to execute a sequence of machine-readable instructions. The instructions may reside in various types of computer readable media. In this respect, another aspect of the present invention concerns a programmed product, comprising computer readable media tangibly embodying a program of machine-readable instructions executable by a digital data processor to perform the method in accordance with an embodiment of the present invention.

This computer readable media may comprise, for example, RAM contained within the system. Alternatively, the instructions may be contained in another computer readable media such as a magnetic data storage diskette and directly or indirectly accessed by the computer system. Whether contained in the computer system or elsewhere, the instructions may be stored on a variety of machine readable storage media, such as a DASD storage (for example, a conventional “hard drive” or a RAID array), magnetic tape, electronic read-only memory, an optical storage device (for example, CD ROM, WORM, DVD, digital optical tape), paper “punch” cards, or other suitable computer readable media including transmission media such as digital, analog, and wireless communication links. In an illustrative embodiment of the invention, the machine-readable instructions may comprise lines of compiled C, C++, or similar language code commonly used by those skilled in the programming for this type of application arts.

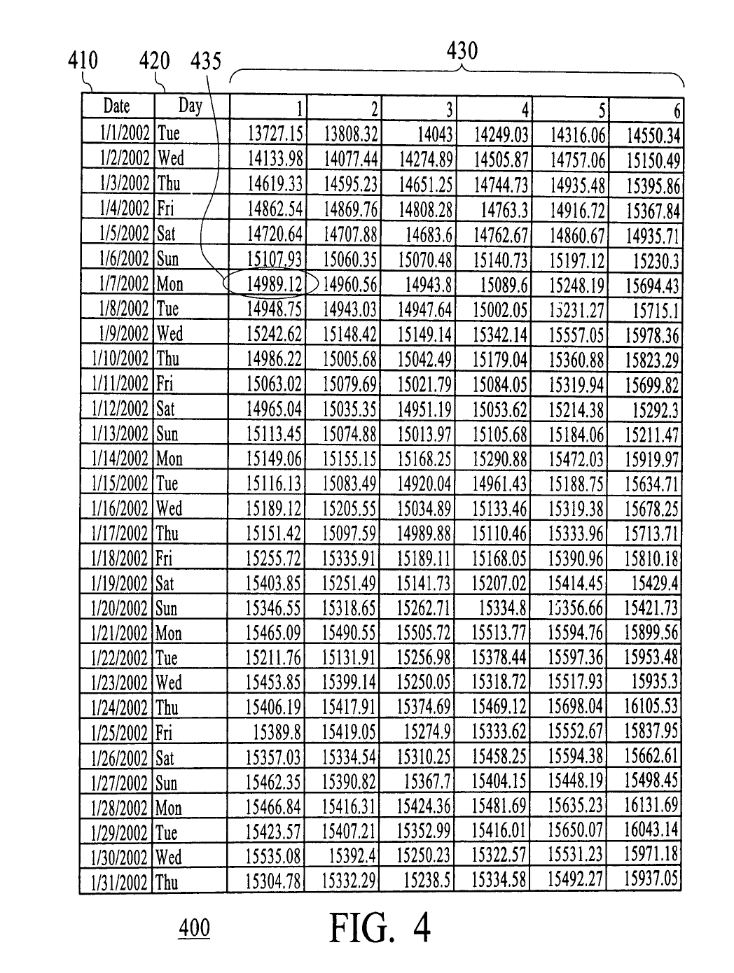

The following is a more detailed description of the method in accordance with an embodiment of the present invention. The process begins with the compilation of energy consumption data in mega watts (MW) per time period (typically hours) over a duration thereby yielding a profile. In embodiment, energy consumption data is compiled via a data matrix. FIG. 4 shows an example of a data matrix 400 in accordance with an embodiment of the present invention. The data matrix 400 encompasses the amount of energy consumed during a predetermined duration and time. It should be understood that the predetermined duration could be any of a variety of durations as well as periods of time. For example, the data could be compiled monthly, quarterly, bi-annually, annually, etc. while remaining within the spirit and scope of the present invention.

In this case, the predetermined duration of time is the month of January 2002 for the period of time of hours 1-6 (12 AM-6 AM) of each day. Accordingly, the data matrix 400 includes a date column 410, a day-of-the-week column 420, and hour columns 430. Each data entry represents the amount of energy consumed for that particular hour of that particular day. For example, item 435 of FIG. 4 represents the amount of energy consumed between 12 AM and 1 AM on Monday Jan. 7, 2002. As shown, the amount of energy is 14989.12 MW.

In an embodiment, separate data matrices are compiled representative of data consumption for “off peak” hours and “peak” hours. Off peak hours are generally designated as hours where energy consumption is minimal (hours 1-6, 23-24). The remaining hours (7-22) are considered peak hours i.e. energy consumption is relatively high. It should be understood by one of ordinary skill in the art that the described process of this patent application can be implemented based on off-peak data consumption and/or peak data consumption while remaining within the spirit and scope of the present invention.

From the data matrix, a block volume of energy to possibly purchase, wherein the block volume is reflective of the historical data consumption rate, is selected. Various block volumes of energy to select from can be generated based on risk components associated with the various block volumes of energy. One method of calculating these volumes is described in patent application serial number ######## entitled “A Method and System for Calculating Risk Components Associated with the Consumption of an Indirect Procurement Commodity”.

Once the block volume of energy is received, this value (in KW) is multiplied by a cost of energy (in dollars per KW), generating a dollar amount. This amount is then multiplied by a period of a predetermined duration thereby generating a cost of the energy for the predetermined duration. In an embodiment, the predetermined duration includes a time factor wherein the time factor includes a number of peak hours or a number of off-peak hours. Basically, the cost of the energy is calculated based on the following relationship:
P=V_{B}*π
where P is the total cost of a block purchase of a block volume, V_{B}, of energy for a period, π, wherein π is the number of days in the period multiplied by the number hours (off-peak or peak) in each day. It should be noted that in an embodiment, the period, π, is a past period that is associated with the future period to be forecasted. For example, if the period to be forecasted is January-March of 2004, then π is representative of January-March of 2003 or some other past January-March time period.

Next, a market imbalance factor is calculated and added to the cost of the energy. With regard to energy purchases, once a volume of energy to be block purchased has been established it should be understood that in some hours, more or less energy than the purchased volume will be used. These overages and deficits of energy are then sold or purchased on the imbalance market at open market prices on a real time basis. Consequently, purchases of these overages and deficits on the imbalance market are taken into account when attempting to forecast a potential future energy cost.

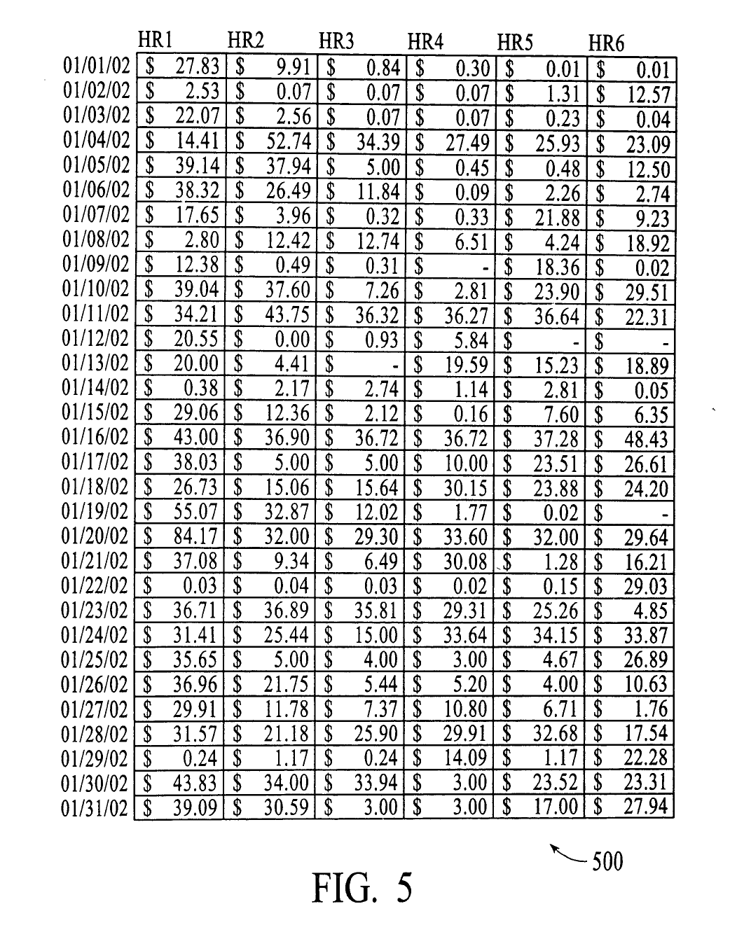

In an embodiment, the market imbalance factor is calculated based on the following relationship:
Mᵢ=(V_{B}−Vᵢ)*xᵢ
where Mᵢ is the market imbalance factor for the cell i in the data consumption matrix, Vᵢ is the actual volume of energy consumption for the cell i, and xᵢ is the index price of energy on the imbalance market for the cell i. (It should be noted that a cell represents an hour block in the data consumption matrix.) In an embodiment, the index prices of energy on the imbalance market are California Independent System Operator (Cal-ISO) index prices and are publicly available. FIG. 5 shows an example of an index price table 500. In this case, the index price table 500 is for the month of January 2002 for the period of time of hours 1-6 (12 AM-6 AM) of each day. Accordingly, each cell in the index price table 500 represents the index price (per MW) of energy for the associated hour.

Thus, a market imbalance factor is calculated for each hour in the predetermined period. For example, if the predetermined period is January-March, historical consumption data is gathered for a past January-March period and accumulated in a data matrix format (similar to that of FIG. 4). The historical consumption data is then utilized in conjunction with publicly available index prices for the same past period to calculate a cumulative market imbalance factor for the past period. Specifically, individual Mᵢ values are calculated for each hour of the period. The individual Mᵢ values are then summed to generate a cumulative market imbalance factor, M_{T} where:
M_{T}=Mᵢ+Mᵢ₊₁+Mᵢ₊₂ . . . Mᵢ₊ₙ
where (i+n) equals the number of cells (or hours) in the past period. The cumulative market imbalance factor M_{T} is then added to the cost of energy P resulting in a value P_{f} where P_{f} equals the total forecasted cost of energy for the period:
P_{f}=M_{T}+P

Finally, an estimated market fluctuation component, φ, is factored into the above-described equation as follows:
P_{f}′=P_{f}*φ
where P_{f}′ represents a corrected forecasted cost of energy based on the market fluctuation component φ. The market fluctuation component, φ, is a “best guess” estimate of how the market may fluctuate during the future period in question. This estimate could be based on publicly available information regarding the indirect procurement commodity in question (e.g. energy) or a variety of other factors. For example, if a 10% increase in the energy market is estimated, a φ value of 1.10 is utilized in the above-disclosed equation.

Although the above-referenced embodiment of the present invention discloses determining the cost of energy for a period of a predetermined duration, one of ordinary skill in the art will readily recognize that the cost of energy for multiple periods could be calculated while remaining within the spirit and scope of the present invention.

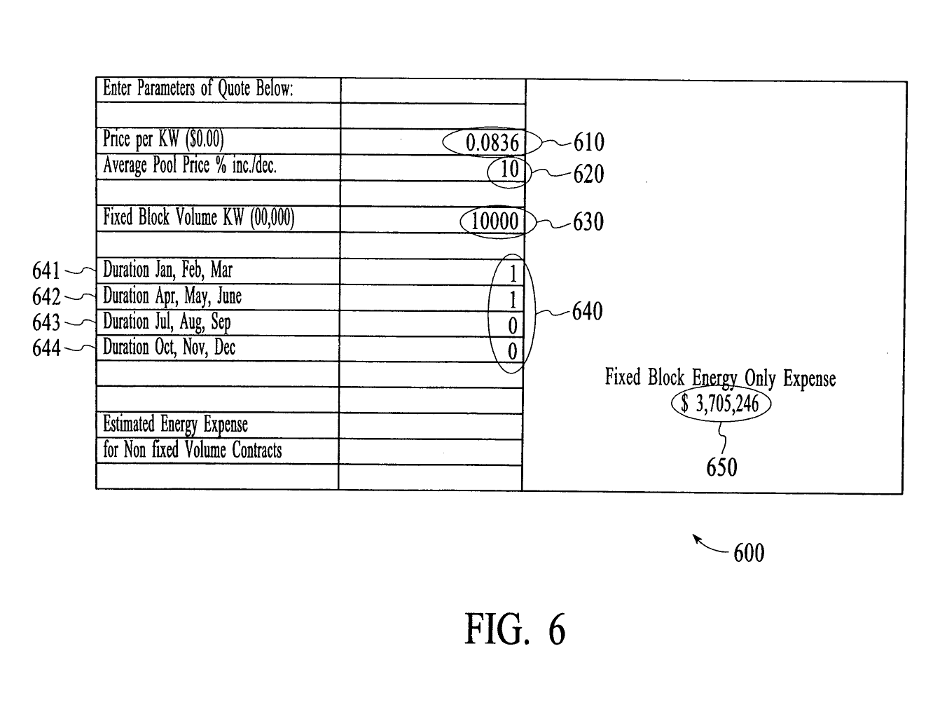

Please refer now to FIG. 6. FIG. 6 is an example of a graphical user interface 600 that could be utilized in conjunction with an embodiment of the present invention. The interface 600 includes a price input area 610, a market fluctuation component input area 620, a fixed volume input area 630, and a period selection area 640. The price input area 610 receives pricing information related to the price of the energy; the market fluctuation component input area 620 receives the best guess estimate of how the market may fluctuate during the period(s) in question; the fixed volume input area 630 receives the fixed volume of energy to be block purchased; and the period selection area 640 includes one or more input areas whereby a user can select which particular periods 641-644 to forecast potential energy costs. Once the user inputs the appropriate values in the appropriate input areas, a results area 650 displays the potential cost of the energy for the selected period(s).

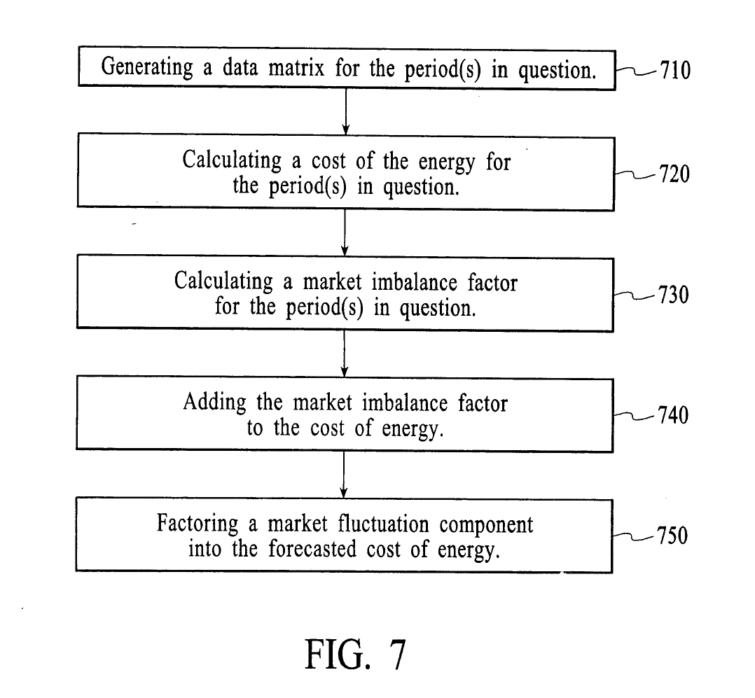

FIG. 7 is a more detailed flowchart of a method in accordance with an embodiment of the present invention. A first step 710 includes generating a data matrix for the period(s) in question. In various embodiments, the data matrix could contain off peak data or peak data for a past period(s). A second step 720 includes calculating a cost of the energy for the period(s) in question. A third step 730 includes calculating a market imbalance factor for the period(s) in question. A fourth step 740 involves adding the market imbalance factor to the cost of the energy. In an embodiment, the market imbalance factor is calculated based on overages and deficits of energy that are sold or purchased on the imbalance market at open market prices on a real time basis. Finally, a fifth step 750 includes factoring a market fluctuation component into the cost of energy. In an embodiment, the market fluctuation component is a best guess estimate of how the market may fluctuate during the future period(s) in question.

A method and system for forecasting a potential cost for an indirect procurement commodity is disclosed. The present invention determines the potential cost associated with block purchases of the indirect procurement commodity by statistically analyzing a history of consumption of the indirect procurement commodity. Based on the determined potential cost, the indirect procurement commodity can be block purchased for a predetermined duration and period of time. Consequently, a substantial reduction in the costs associated with the purchase of indirect procurement commodities can be achieved.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for forecasting a potential cost for an indirect procurement commodity comprising:
receiving a volume of the indirect procurement commodity to be block purchased for a future period;
calculating a cost of the volume of the indirect procurement commodity based on historical consumption data for a past period; and
forecasting a potential cost of the indirect procurement commodity to be purchased for a future period based on the calculated cost and at least one variable factor associated with the indirect procurement commodity.

2. The method of claim 1 wherein the indirect procurement commodity comprises energy.

3. The method of claim 1 wherein calculating a cost of the volume comprises:
multiplying the volume of the indirect procurement commodity by a time factor wherein the time factor is associated with the past period.

4. The method of claim 3 wherein the time factor comprises a number of off-peak hours in the past period.

5. The method of claim 3 wherein the time factor comprises a number of peak hours in the past period.

6. The method of claim 1 wherein forecasting a potential cost of the indirect procurement commodity further comprises:
calculating the at least one variable.

7. The method of claim 6 wherein calculating the at least one variable further comprises:
calculating a market imbalance factor for the future period based on data associated with the past period.

8. The method of claim 7 wherein data associated with the past period comprises consumption data and price index data.

9. The method of claim 8 wherein forecasting the potential cost of the indirect procurement commodity further comprises:
adding the market imbalance factor to the cost of the volume of the indirect procurement commodity thereby generating a forecasted cost of the volume of the indirect procurement commodity.

10. The method of claim 9 wherein forecasting the potential cost of the indirect procurement commodity further comprises:
factoring a market fluctuation component into the forecasted cost of the volume of the indirect procurement commodity.

11. The method of claim 10 wherein the market fluctuation component comprises a best guess estimate of market fluctuation during the future period.

12. A system for forecasting a potential cost for an indirect procurement commodity comprising:
means for receiving a volume of the indirect procurement commodity to be block purchased for a future period;
means for calculating a cost of the volume of the indirect procurement commodity based on historical consumption data for a past period; and
means for forecasting a potential cost of the indirect procurement commodity to be purchased for a future period based on the calculated cost and at least one variable factor associated with the indirect procurement commodity.

13. The system of claim 12 wherein the means for determining a cost of the volume comprises:
means for multiplying the volume of the indirect procurement commodity by a time factor wherein the time factor is associated with the past period.

14. The system of claim 13 wherein the time factor comprises a number of off-peak hours in the past period.

15. The system of claim 13 wherein the time factor comprises a number of peak hours in the past period.

16. The system of claim 12 wherein the means for forecasting a potential cost of the indirect procurement commodity further comprises:
means for calculating the at least one variable.

17. A system for forecasting a potential cost for an indirect procurement commodity comprising:
a graphical user interface; and
a cost forecasting tool coupled to the graphical user interface capable of:
receiving a volume of the indirect procurement commodity to be block purchased for a future period;
calculating a cost of the volume of the indirect procurement commodity based on historical consumption data for a past period; and
forecasting a potential cost of the indirect procurement commodity to be purchased for a future period based on the calculated cost and at least one variable factor associated with the indirect procurement commodity.

18. The system of claim 17 wherein forecasting a potential cost of the indirect procurement commodity further comprises:
calculating the at least one variable factor.

19. The system of claim 18 wherein calculating the at least one variable factor further comprises:
calculating a market imbalance factor for the future period based on data associated with the past period.

20. The system of claim 19 wherein data associated with the past period comprises consumption data and price index data.

21. The system of claim 20 wherein forecasting the potential cost of the indirect procurement commodity further comprises:
adding the market imbalance factor to the cost of the volume of the indirect procurement commodity thereby generating a forecasted cost of the volume of the indirect procurement commodity.

22. The system of claim 21 wherein forecasting the potential cost of the indirect procurement commodity further comprises:
factoring a market fluctuation component into the forecasted cost of the volume of the indirect procurement commodity.

23. The system of claim 22 wherein the market fluctuation component comprises a best guess estimate of market fluctuation during the future period.

24. A computer program product for forecasting a potential cost for an indirect procurement commodity, the computer program product comprising a computer usable medium having computer readable program means for causing a computer to perform the steps of:
receiving a volume of the indirect procurement commodity to be block purchased for a future period;
calculating a cost of the volume of the indirect procurement commodity based on historical consumption data for a past period; and
forecasting a potential cost of the indirect procurement commodity to be purchased for a future period based on the calculated cost and at least one variable factor associated with the indirect procurement commodity.

25. The computer program product of claim 24 wherein forecasting a potential cost of the indirect procurement commodity further comprises:
calculating the at least one variable factor.

26. The computer program product of claim 25 wherein calculating the at least one variable factor further comprises:
calculating a market imbalance factor for the future period based on data associated with the past period.

27. The computer program product of claim 26 wherein data associated with the past period comprises consumption data and price index data.

28. The computer program product of claim 27 wherein forecasting the potential cost of the indirect procurement commodity further comprises:
adding the market imbalance factor to the cost of the volume of the indirect procurement commodity thereby generating a forecasted cost of the volume of the indirect procurement commodity.

29. The computer program product of claim 28 wherein forecasting the potential cost of the indirect procurement commodity further comprises:
factoring a market fluctuation component into the forecasted cost of the volume of the indirect procurement commodity.

30. A method of doing business comprising:
receiving a volume of the indirect procurement commodity to be block purchased for a future period;
calculating a cost of the volume of the indirect procurement commodity based on historical consumption data for a past period; and
forecasting a potential cost of the indirect procurement commodity to be purchased for a future period based on the calculated cost and at least one variable factor associated with the indirect procurement commodity.

31. The method of claim 30 wherein the indirect procurement commodity comprises energy.

32. The method of claim 30 wherein forecasting a potential cost of the indirect procurement commodity further comprises:
calculating the at least one variable.

33. The method of claim 32 wherein calculating the at least one variable further comprises:
calculating a market imbalance factor for the future period based on data associated with the past period.

34. The method of claim 33 wherein data associated with the past period comprises consumption data and price index data.

35. The method of claim 34 wherein forecasting the potential cost of the indirect procurement commodity further comprises:
adding the market imbalance factor to the cost of the volume of the indirect procurement commodity thereby generating a forecasted cost of the volume of the indirect procurement commodity.
